(19) United States
(12) Patent Application Publication
(10) Pub. No.: US 2025/0383206 A1
(43) Pub. Date: Dec. 18, 2025

(54) INERTIAL MEASUREMENT UNIT-ENHANCED TWO-WAY RANGING

(71) Applicant: Battelle Memorial Institute, Columbus, OH (US)

(72) Inventor: Garrett Dowd, Columbus, OH (US)

(21) Appl. No.: 19/227,758

(22) Filed: Jun. 4, 2025

Related U.S. Application Data
(60) Provisional application No. 63/658,997, filed on Jun. 12, 2024.

(51) Int. Cl. G01C 21/16; G01C 19/5776; G01C 25/00

(52) U.S. Cl. CPC G01C 21/1652; G01C 19/5776; G01C 25/005

(57) ABSTRACT

In an approach to two-way ranging, a system includes a first entity. The first entity includes: a first inertial measurement unit (IMU) circuitry configured to measure a first change in position of the first entity; radio circuitry configured to communicatively couple with one or more additional entities; and processor circuitry. The processor circuitry is configured to: measure a range to a second entity using two way ranging (TWR); receive an odometry measurement from the second entity; and determine a range estimation to the second entity based on a previous range to the second entity and the odometry measurement.

### CROSS-REFERENCE TO RELATED APPLICATIONS

The present application claims the benefit of the filing date of U.S. Provisional Application Ser. No. 63/658,997, filed Jun. 12, 2024, the entire teachings of which application is hereby incorporated herein by reference.

### STATEMENT REGARDING FEDERALLY SPONSORED RESEARCH OR DEVELOPMENT

Not applicable.

### TECHNICAL FIELD

The present disclosure relates generally to two-way ranging (TWR) and, more particularly, to a system and method for inertial measurement unit (IMU)-enhanced TWR.

### BACKGROUND

An IMU is an electronic device that measures and reports a body's specific force, angular rate, and the orientation of the body, using a combination of accelerometers, gyroscopes, and magnetometers which measure linear acceleration, angular velocity, and magnetic field strength (to orient with respect to the Earth's axes), respectively. An IMU may be based on Micro Electro-Mechanical Systems (MEMS) technology.

IMUs are typically used to maneuver modern vehicles including motorcycles, missiles, aircraft (an attitude and heading reference system), including uncrewed aerial vehicles (UAVs) and consumer drones, among many others. Besides navigational purposes, IMUs serve as orientation sensors in many products. For example, almost all smartphones and tablets contain IMUs as orientation sensors.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system for IMU-enhanced TWR consistent with the present disclosure.

FIG. 2A is an example of one dimensional (1D) ranging consistent with the present disclosure.

FIG. 2B is a table of measured versus actual range for the example of FIG. 2A.

FIG. 3 is chart illustrating the divergence between the estimated and actual range for the example of FIG. 2A, consistent with the present disclosure.

FIG. 4A is a diagram of one example of message data packing for the system for IMU-enhanced TWR consistent with the present disclosure.

FIG. 4B is an example of one possible method to detect a Non-Line-of-Sight (NLOS) condition for the message data packing example of FIG. 4A.

FIG. 4C is a sample from FIG. 4B where an NLOS condition is not detected.

FIG. 4D is a sample from FIG. 4B where an NLOS condition is detected.

FIGS. 5A and 5B illustrate one possible method to insert data into a standardized message.

FIGS. 6A and 6B are an example illustrating the measured versus actual two dimensional (2D) range for an entity in the example of FIG. 2A.

FIG. 7 is an example of time synchronization using time-of-flight (ToF) for the IMU-enhanced TWR consistent with the present disclosure.

FIG. 8 is an example of the coordinate uncertainty associated with unmeasured relative motion or significant IMU drift.

FIG. 9 is an example of coordinate frame alignment when the transform between the x,y and x′,y′ coordinate frames is unknown.

FIG. 10 is an example of coordinate frame alignment when the transform between the x,y and x′,y′ coordinate frames is known.

FIG. 11 is a flowchart diagram depicting a process for inertial measurement unit (IMU)-enhanced TWR, on the system of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

The problem with existing TWR systems is that they suffer from precision issues. TWR measurements are susceptible to noise caused by NLOS, multipath conditions that either obstruct the line-of-sight signal such that only reflected signals are received, which is more prominent at higher frequencies, or reduce the phase velocity of the line-of-sight signal below the expected/assumed value, which is more prominent at lower frequencies. Radios are mobile and move through an unstructured/unknown environment. Radios typically operate between 2-10 GHz with a 500-1000 MHz bandwidth. A goal for TWR systems is to maintain measurement precision during NLOS of approximately ten centimeters. Unmitigated NLOS, however, can cause precision to exceed five thousand centimeters.

Existing solutions may include adding additional infrastructure to avoid NLOS and using Bayesian filtering supplemented by NLOS identification algorithms. These existing solutions may also utilize polarization to reduce/eliminate reflected signals and dead-reckoning to improve position estimates over short time horizons. Both polarization and dead-reckoning are commonly utilized by global navigation satellite system (GNSS) receivers.

However, Bayesian filtering may perform poorly when used to estimate the motion of pedestrians or other dynamic systems that have limited or uncertain kinematic models. Existing solutions may overcome this limitation by using a Time Difference of Arrival (TDOA) architecture, which commonly requires permanently installed infrastructure, to provide higher performance positioning in structured environments. Because TDOA solutions require fixed mounting infrastructure, a static operational area, and installation prior to use they may not be suitable for many applications. Therefore, improving TWR performance, especially in unstructured dynamic environments, may enable new applications in areas such as robotics, search and rescue, construction, and logistics.

Disclosed herein is a system and method to generate, transmit, and reconstruct dead-reckoning (DR) estimates over two way ranging networks that greatly improves NLOS precision. The disclosed system includes quantifiable benefits similar to fusing GNSS and DR. The system provides more deterministic precision in a wider range of environments, and overall better precision, while adding minimal size, weight, power, and cost (SWAPC) and no additional signature over baseline TWR.

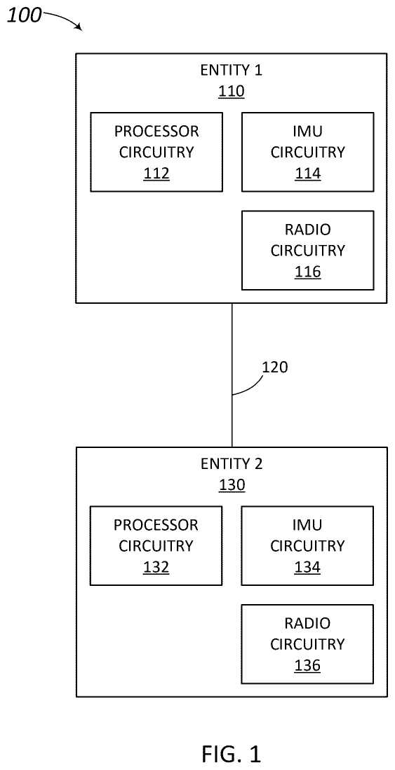

FIG. 1 is a functional block diagram illustrating an example system 100 for IMU-enhanced TWR consistent with the present disclosure. The example system 100 of FIG. 1 includes entity-1 110 and entity-2 130. System 100 shows only two entities for convenience, however, it should be noted that any number of entities may be implemented, as would be known to one skilled in the art. The example of FIG. 1 also includes connection 120 to communicatively couple each of the entities.

In an embodiment, entity-1 110 includes processor circuitry 112, IMU circuitry 114, and radio circuitry 116. Processor circuitry 112 may be, for example, a microcontroller or other computing device, and may include non-transitory storage media to store instructions to perform the range and bearing calculations. IMU circuitry 114 may include a 3-axis accelerometer and a 3-axis gyroscope, making it a 6-axis IMU. IMU circuitry 114 may also include a 3-axis magnetometer, making it a 9-axis IMU. Radio circuitry 116 may be, for example, a UWB radio, and may be configured to communicatively couple with one or more additional entities, for example, entity-2 130.

In an embodiment, connection 120 may be a wireless connection, such as a UWB wireless connection. In an embodiment, the UWB radios may operate in a range between 2.0 GHz and 10.0 GHz.

In an embodiment, entity-2 130 includes processor circuitry 132, IMU circuitry 134, and radio circuitry 136. Processor circuitry 132 may be, for example, a microcontroller or other computing device, and may include non-transitory storage media to store instructions to perform the range and bearing calculations. IMU circuitry 134 may include a 3-axis accelerometer and a 3-axis gyroscope, making it a 6-axis IMU. IMU circuitry 134 may also include a 3-axis magnetometer, making it a 9-axis IMU. Radio circuitry 136 may be, for example, a UWB radio, and may be configured to communicatively couple with one or more additional entities, for example, entity-1 110.

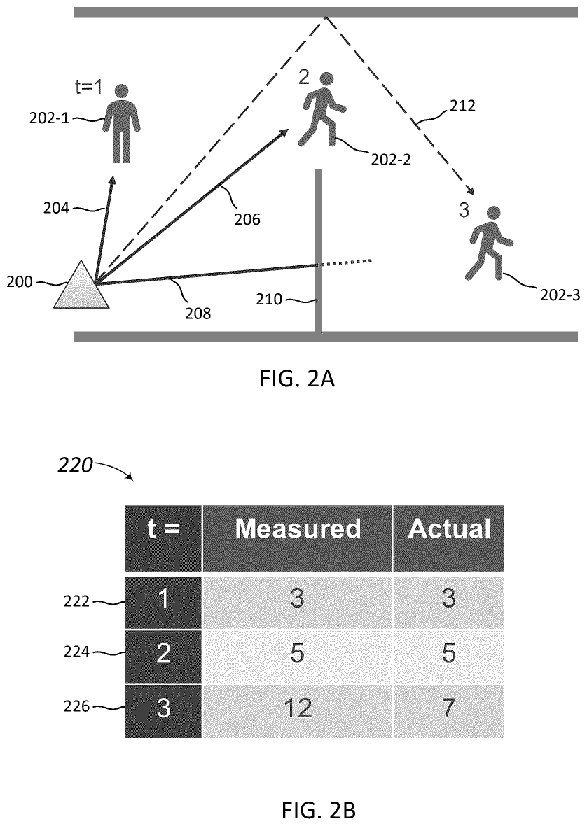

FIG. 2A is an example of one dimensional (1D) ranging consistent with the present disclosure. As used in this disclosure, the term 1D ranging refers to positioning dimensionality where the ranging only construes length. In an embodiment, 1D ranging may be based on TWR only. The term two dimensional (2D) ranging refers to positioning dimensionality where the ranging construes length and relative position in a 2D space. In an embodiment, 2D ranging may be based on TWR and angle of arrival (AoA) using a two or more element antenna array. The term three dimensional (3D) ranging refers to positioning dimensionality where the ranging construes length and relative position in a 3D space. In an embodiment, 3D ranging may be based on TWR and AoA using a three or more element antenna array.

In the example of FIG. 2A, a first entity 200, which may be, for example, entity-1 110 from FIG. 1, is tracking the range to a second entity 202, which may be, for example, entity-2 130 from FIG. 1. The second entity 202 is at a first position at time 1, denoted by 202-1 in FIG. 2A, which is within the line of sight of the first entity 200. At time 1 the range is measured using TWR 204. The result of this measurement can be seen in line 222 of table 220 in FIG. 2B. In line 222, since the second entity 202 is within the line of sight of the first entity 200, the measured range and the actual range to the second entity 202 are both 3.

When the second entity 202 has moved to a second position at time 2, denoted by 202-2 in FIG. 2A, it is still within the line of sight of the first entity 200. At time 2 the range is measured using TWR 206. The result of this measurement can be seen in line 224 of table 220 in FIG. 2B. In line 224, since the second entity 202 is still within the line of sight of the first entity 200, the measured range and the actual range to the second entity 202 are both 5.

When the second entity 202 has moved to a third position at time 3, denoted by 202-3 in FIG. 2A, it is no longer within the line of sight of the first entity 200. At time 3 the range is measured using TWR 208. However, the TWR signal 208 is blocked by an obstruction 210, so the actual measurement of the range to the second entity is captured by TWR 212, which is a reflected signal. The result of this measurement can be seen in line 226 of table 220 in FIG. 2B. In line 226, since the second entity 202 is not within the line of sight of the first entity 200, the measured range to the second entity 202 is 12, because the signal is reflected and not direct, but the actual range to the second entity 202 is 7.

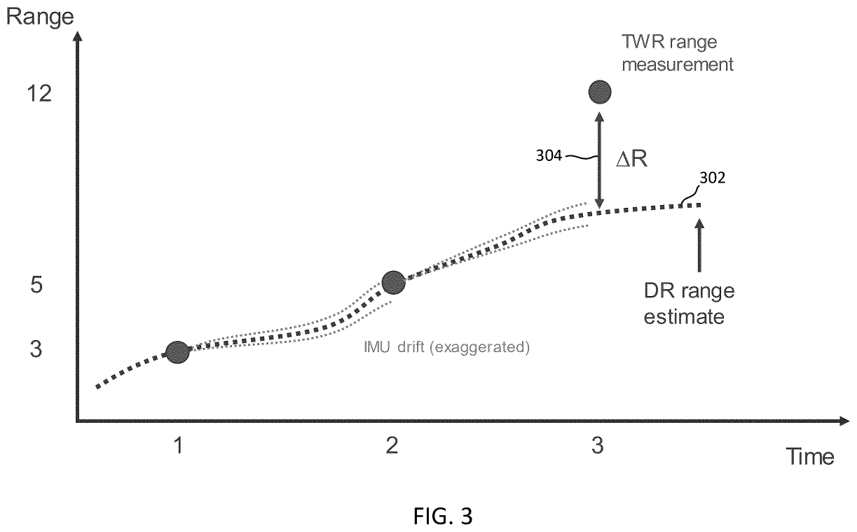

FIG. 3 is chart illustrating the divergence between the estimated and actual range for the example of FIG. 2A, consistent with the present disclosure. The chart of FIG. 3 further illustrates the divergence between the TWR range measurements and DR range estimates. In an embodiment this divergence may be used to detect an NLOS condition. The chart in FIG. 3 represents the three measurement points from FIG. 2A, the first having a measured range of 3, the second having a measured range of 5, and the third having a measured range of 12. The divergence 304, represented as AR, is the variance from the DR estimate 302. When the divergence 304 exceeds a predetermined threshold, the second entity is considered to be in an NLOS condition.

In an embodiment, the threshold used to identify divergence is determined by multiple system parameters including time between ranging (TBR), IMU drift, and entity dynamics. IMU drift can be reduced by using a higher performance IMU. Depending on application needs, a performance versus cost curve may be established to optimize system design. In an embodiment, the waveform characteristics of the received signal can be analyzed to detect and supplement NLOS identification.

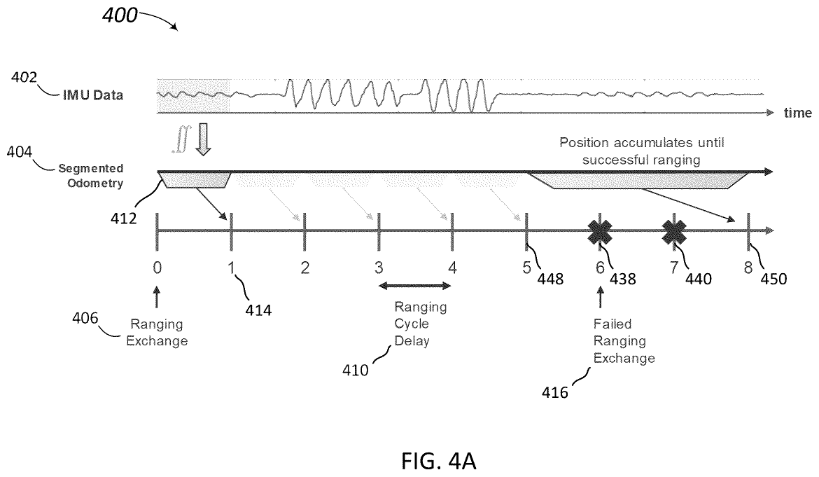

FIG. 4A is a diagram 400 of one example of message data packing for the system for IMU-enhanced TWR consistent with the present disclosure. The example of diagram 400 illustrates how DR estimates are deconstructed and packaged to be sent via a TWR exchange. The example of diagram 400 illustrates a high-level overview of the process and its robustness to short-term communication failure. It should be noted however that the example of FIG. 4A is shown for illustrative purposes only. Many other methods of packaging DR estimates into a TWR exchange are possible, as would be known to one skilled in the art.

In diagram 400 the second entity, i.e., the entity whose position is being tracked by the first entity, includes an IMU. The IMU data 402 from the second entity is a continuous data stream. The continuous IMU data 402 is discretized into a segmented odometry 404. The segmented odometry 404 may be discretized, for example, to one or two measurements per second, although the rate may be higher or lower depending on the application.

The DR estimates may be packaged such that only a relative change in position (i.e., the segmented odometry) since the last exchange is transmitted to the entity. In this way, only limited information about the entity's location is revealed to a malicious actor to effectively maintain a high level of privacy inherent to TWR.

The segmented odometry 404 is sent to the first entity by the second entity as discrete ranging exchanges 406 based on a ranging cycle delay 410. For example, the first illustrated sample of the segmented odometry 404, sample-0 412, is transmitted to the first entity as exchange-1 414. In the example of FIG. 4A, exchange-6 438 and exchange-7 440 are failed ranging exchanges, and exchange-5 448 and exchange-8 450 are NLOS exchanges, which will be explained in FIG. 4B.

As shown in the example of FIG. 4A, position is accumulated during the ranging cycle delay 410 (i.e., is added to the odometer) and sent during the ranging exchange 406 and is reset upon a successful ranging exchange (i.e., the odometer is reset to zero).

FIG. 4B is an example of one possible method to detect an NLOS condition for the message data packing example of FIG. 4A. Table 420 is an example of a series of ranging exchanges 406 from FIG. 4A. To make the following explanation clearer, table 420 includes an actual range in row 422, which is the actual range between the first entity, i.e., the entity performing the ranging, and the second entity, i.e., the entity being tracked, a measured range to entity 1 in row 424, which is the range determined by entity 1 using TWR, an odometry measurement from the second entity in row 426, and a range estimation to the second entity by the first entity in row 428. The first entity measures the position of the second entity using TWR (row 424) and receives position odometry (row 426) from the second entity. The first entity compares the measured range (row 424) and the accompanying odometry measurements (row 426) to look for inconsistencies that may indicate NLOS. In an embodiment, if the measured range and a range estimation based on the odometry measurements differ by a predetermined distance, then an NLOS condition exists between the first entity and the second entity. In this example, disagreement between the measured range and the odometry measurements occur at ranging exchange-5 448 and exchange-8 450 indicating NLOS. The first entity can then choose to trust the odometry over the measured range. In an embodiment, this may be implemented as a Bayesian filter.

FIG. 4C is a sample from FIG. 4B where an NLOS condition is not detected. In the example of FIG. 4C, the first entity adds the current odometry measurement 434 (value equals −1) to the previous measured range 430 (value equals 5), and in this case the result matches the current measured range 432 (value equals 4), and therefore no NLOS is detected.

FIG. 4D is a sample from FIG. 4B where an NLOS condition is detected. In the example of FIG. 4D, the first entity adds the current odometry measurement from exchange-7 440 (value equals 0) to the previous measured range 436 (value equals 3), and in this case the result (value equals 3) does not match the current measured range 438 (value equals 6). The discrepancy between the calculated range and the measured range (by the TWR) indicates an NLOS condition.

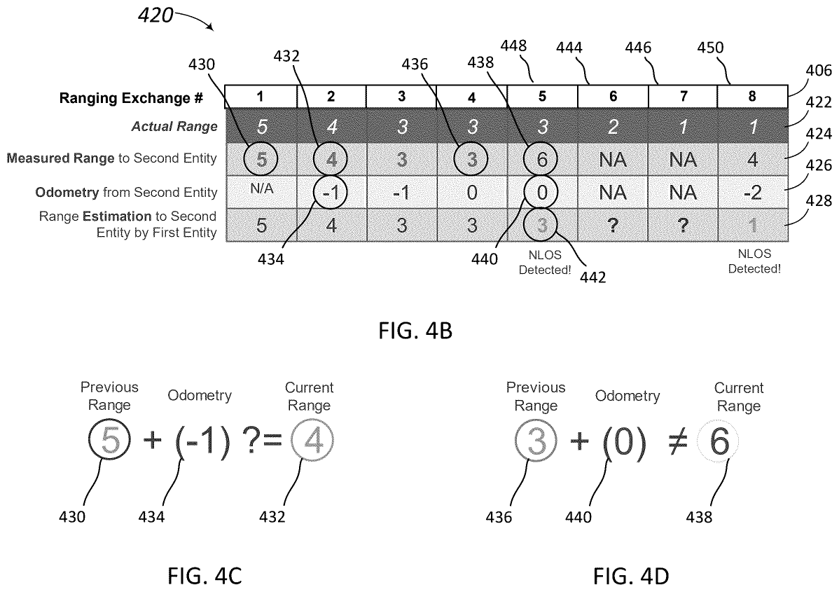

FIGS. 5A and 5B illustrate one possible method to insert data into a standardized message. FIG. 5A illustrates an example of a ranging exchange between two entities, entity-1 510 and entity-2 520. In this example, entity-1 510 sends a DR id request 514 to entity-2 520. The DR id is an identification number of the last successful ranging cycle. The DR id request 514 is received by entity-2 520 after a time ToF₁ 522. In an embodiment, the ToF₁ 522 may be used to measure the range between entity-1 510 and entity-2 520. After a time of T_{reply} 528, entity-2 520 returns a DR payload response 524 to entity-1 510. The DR payload response 524 is received by entity-1 510 after a time ToF₂ 526. In an embodiment, the ToF₂ 526 may be used to measure the range between entity-1 510 and entity-2 520. In an embodiment, the response time Tᵣₑₛₚₒₙₛₑ 518, ToF₁ 522, ToF₂ 526, and T_{reply} 528 may be used to measure the range between entity-1 510 and entity-2 520, Range=(ToF₁+ToF₂)/2=(Tᵣₑₛₚₒₙₛₑ−T_{reply})/2

In the above example, entity-2 520 could delete accumulated position data based on the DR id request 514. This would save storage/memory space on embedded devices. For example, if entity-1 510 requests DR id #5 then it is assumed that previous requests were successful or the previous data is no longer needed, and data up to DR id #5 could be deleted.

FIG. 5B is an example of inserting the DR payload, for example, DR payload response 524, into a message. In some embodiments, the DR payload response 524 message may be a standard message, such as the IEEE 802.15.4 format used in the example of FIG. 5B, but any other messaging format could be used depending on the application.

Here the DR payload is nominally 4-6 bytes, which may support up to 65 meters of position change between successful ranging exchanges. The accumulated position change for each axis, X_{acm} 534, Y_{acm} 536, and Z_{acm} 538, are inserted into the Media Access Control (MAC) payload field 532 of packet 530. The X_{acm}, for example, is the accumulated position change in X direction since the DR id in the request (e.g., units in centimeters), while the Y_{acm} is the accumulated position change in the Y direction and the Z_{acm} is the accumulated position change in the Z direction. In an embodiment, the payload may be generic enough to allow integrators to develop their own DR and fusion algorithms, yet specific enough to become part of a standard that promotes interoperability (e.g., standards from the FiRa Consortium). In some embodiments, the messaging standard may require an additional configuration message.

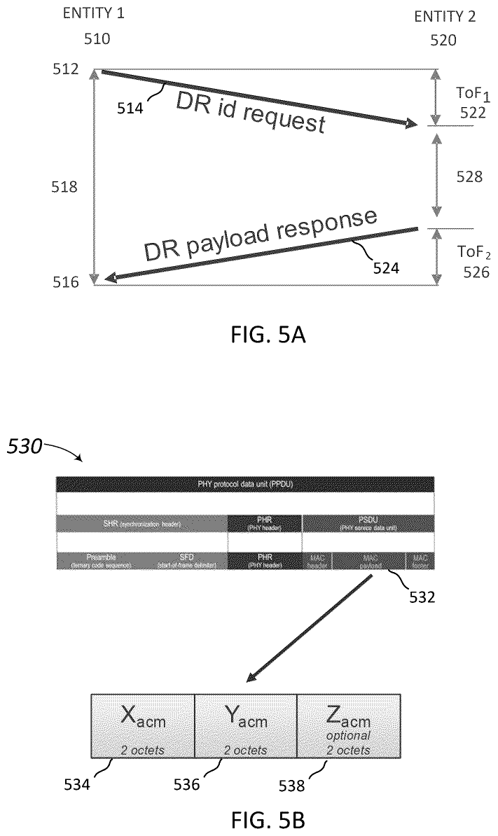

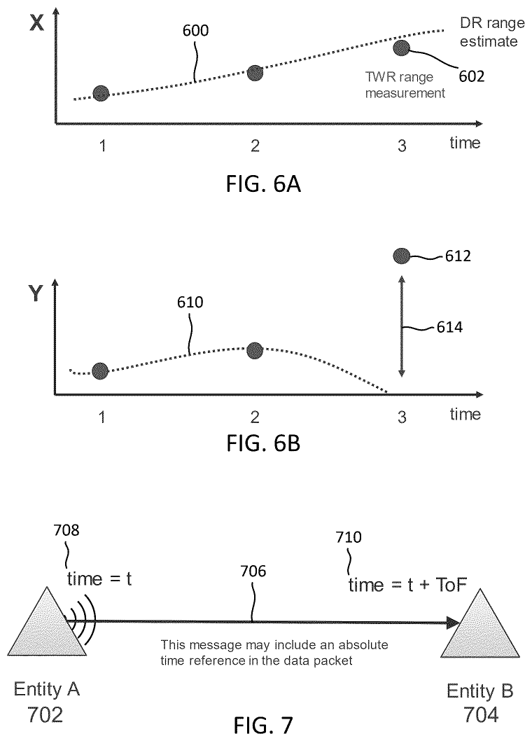

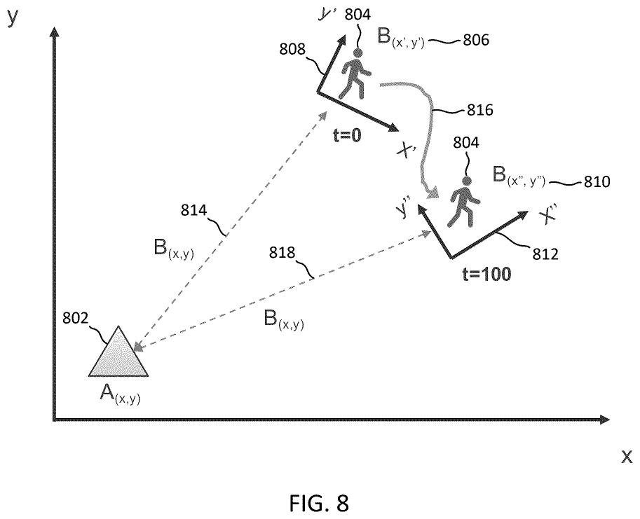

FIGS. 6A and 6B are an example illustrating the measured versus actual 2D range for an entity in the example of FIG. 2A. The example of FIGS. 6A and 6B assumes the entity is capable of measuring AoA from the TWR signal, and also assumes a shared time reference and a shared coordinate frame. The shared time reference is discussed in FIG. 7, and the shared coordinate frame is discussed in FIGS. 8-10.

FIG. 6A is a graph of the range estimate in the X-axis versus time, and FIG. 6B is a graph of the range estimate in the Y-axis versus time. FIG. 6A includes a DR range estimate 600, and a TWR range measurement 602 occurring at a time 3. FIG. 6B includes a DR range estimate 610, and a TWR range measurement 612 also occurring at a time 3. At time 3 there is an NLOS condition, and the resulting DR range estimate is a reflected measurement. In FIG. 6B at time 3, the entity measures the angle of arrival of the reflected signal and the associated reflected length. This results in a large divergence 614 of the IMU and TWR/AoA estimates for the Y axis, which indicates the NLOS condition.

The example illustrated in FIGS. 6A and 6B assumes a shared time reference and a shared coordinate frame. Since the system may utilize sensor measurements from separate entities that do not share a common time reference or coordinate frame, in an embodiment the system may estimate or reconstruct a shared time reference and coordinate frame from assumed characteristics, measured characteristics, or known system characteristics. Time and coordinate frame transforms can then be used with common Bayesian filtering techniques to fuse the measurements. Depending on available assumptions, sensor data, or system characteristics it may be necessary to combine reconstruction and fusion into a single process similar to Simultaneous Localization and Mapping.

Various methods may be used to reconstruct a shared time reference and coordinate frame, as would be known to one skilled in the art. For timing synchronization, the method used may be dependent on the ranging method in use. The ranging method may be single-sided, where only one of the two devices estimates the distance between them, double-sided, which uses three to four messages to more accurately determine the range between two stations, or asymmetric double-sided, which uses an asymmetric number of ranging exchanges to more efficiently range between multiple entities in certain network architectures.

Coordinate frame alignment is dependent on the positioning dimensionality. As discussed above, the positioning dimensionality of the disclosed system may include, but is not limited to, 1D, using TWR only, 2D, using TWR with a two-element AoA, and 3D, using TWR and a three-element AoA. The coordinate frame alignment may also depend on the degrees of freedom of the IMU used. For example, an entity may include an IMU with nine degrees of freedom consisting of a three axis accelerometer, a three axis gyroscope, and a three axis magnetometer, although any other number of degrees of freedom and any other combination of accelerometers, gyroscopes, and magnetometers may be used.

FIG. 7 is an example of time synchronization using ToF for the IMU-enhanced TWR consistent with the present disclosure. In the example of FIG. 7, a message 706 is sent from entity A 702 to entity B 704. In an embodiment, this message may include an absolute time reference in the data packet. The ranging exchange is initiated by entity A 702 at a first time t and is received by entity B 704 at a second time t+ToF, where ToF is the time of flight for the message. Entity B 704 can determine a time synchronization factor using the formula sync factor=t−(t+ToF)=−ToF. Entity B 704 can then estimate the transmit time from entity A 702 by subtracting ToF from a local received time. The ToF is calculated from the two way ranging exchange and is the same ToF used to produce the range measurement.

Thus, ToF accuracy and time synchronization accuracy are directly correlated. For example, impulse radio ultra-wideband (IR-UWB) can measure ToF to nanosecond accuracy via TWR, providing both range measurement and time synchronization.

FIG. 8 is an example of the coordinate uncertainty associated with significant IMU drift. In the example of FIG. 8, entity A 802 measures the relative position of entity B 804 at a first position 806, which is represented in a first coordinate frame 808, via TWR 814. Entity B 804 then moves to a second position 810, and entity A 802 measures the relative position of entity B 804 at the second position 810, which is represented in a second coordinate frame 812, via TWR 818. Entity B 804 also measures its own change in position via an IMU 816. Therefore, the transform between coordinate frame x,y for the position of entity A 802, the coordinate frame 808 x′,y′ at position 806, or the coordinate frame 812 x″,y″ at position 810 is unknown. The example of FIG. 8 illustrates the coordinate uncertainty associated with significant IMU (yaw) drift, which is a common phenomenon with an IMU based on MEMS due to noise and discretization errors.

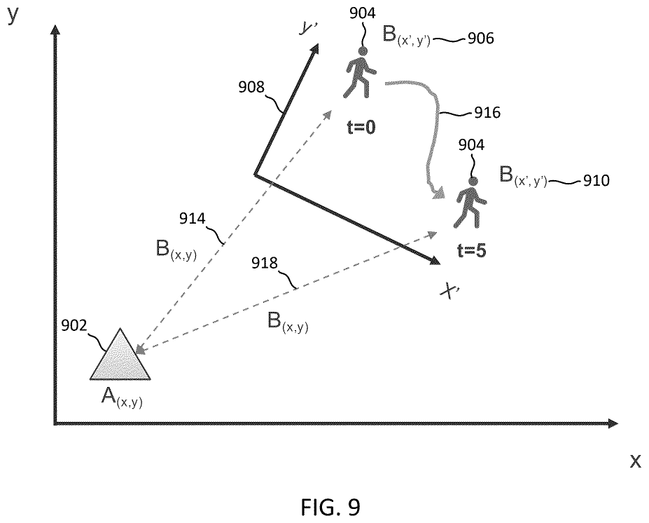

FIG. 9 is an example of coordinate frame alignment when the transform remains constant between measurement periods. In the example of FIG. 9, entity A 902 measures the relative position of entity B 904 at a first position 906, which is represented in a coordinate frame 908, via TWR 914. Entity B 904 then moves to a second position 910, and entity A 902 measures the relative position of entity B 904 at the second position 910, which is still represented in the same coordinate frame 908, via TWR 918. Entity B 904 also measures its own change in position via an IMU 916.

In this example, the transform between the coordinate frame for entity A 902, x,y and the coordinate frame for entity B 904, x′,y′ is unknown. This example assumes that the transform remains constant between measurement periods, or changes only a negligible amount over the useful time horizon. The useful time horizon will depend on the drift characteristics of the MEMS IMU being used. In an embodiment, the transformation could be estimated using a filtered series of position measurements (e.g., an extended Kalman filter using a motion model or a particle filter). In an embodiment, entity B 904 could use an IMU to orient itself in constant magnetic and gravitational fields such that a constant coordinate frame 908 is maintained between positions 906 and 910.

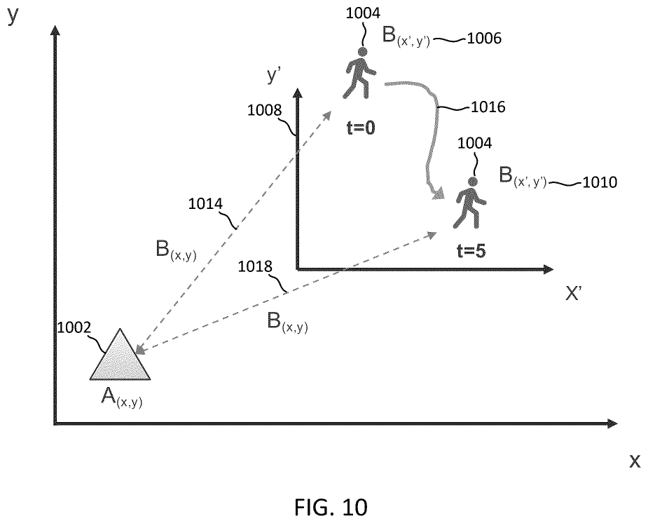

FIG. 10 is an example of coordinate frame alignment when the transform is known or measured. In the example of FIG. 10, entity A 1002 measures the relative position of entity B 1004 at a first position 1006, which is represented in a coordinate frame 1008, via TWR 1014. Entity B 1004 then moves to a second position 1010, and entity A 1002 measures the relative position of entity B 1004 at the second position 1010, which is still represented in the same coordinate frame 1008, via TWR 1018. Entity B 1004 also measures its own change in position via an IMU 1016.

In this example, the transform between the coordinate frame for entity A 1002, x,y and the coordinate frame for entity B 1004, x′,y′ is known or measured. In an embodiment, the transform may be calculated from magnetometer measurements. In another embodiment, DR estimates will use an agreed upon absolute direction reference (e.g., Earth's magnetic field) such that the coordinate transform between the entities is only a translation (as measured by TWR). This assumes both entities are in a similar magnetic field, which is a reasonable assumption for an environment free of metal and inductive electronics such as motors. Under this assumption, fusing sensor measurements becomes trivial. However, it may still be useful to estimate the transform using motion measurements (see FIG. 9). This may improve performance in environments with locally variant magnetic fields.

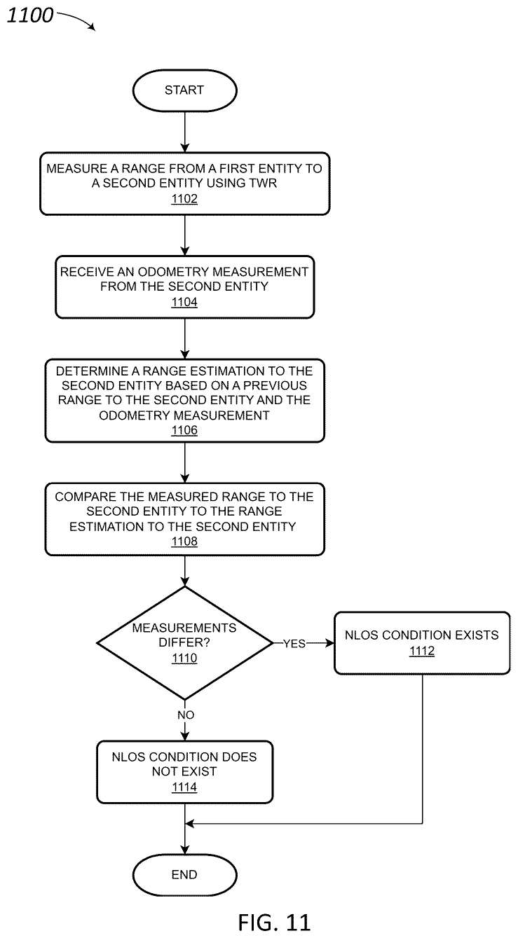

FIG. 11 is a flowchart diagram depicting a process 1100 for inertial measurement unit (IMU)-enhanced TWR, on the system of FIG. 1, consistent with the present disclosure. It should be appreciated that embodiments of the present disclosure provide at least for inertial measurement unit (IMU)-enhanced TWR. However, FIG. 11 provides only an illustration of one implementation and does not imply any limitations with regard to the environments in which different embodiments may be implemented. Many modifications to the depicted environment may be made by those skilled in the art without departing from the scope of the disclosure as recited by the claims.

Process 1100 includes measuring a range from a first entity to a second entity using TWR (operation 1102). In the illustrated example embodiment, the first entity measures a range to the second entity using TWR using an IMU. IN an embodiment, the first entity may measure the range to the second entity using 1D ranging, i.e., based on TWR only, 2D ranging based on TWR and an AOA using a two or more element antenna array, or 3D ranging, i.e., based on TWR and AoA using a three or more element antenna array.

Process 1100 includes receiving an odometry measurement from the second entity (operation 1104). In operation 1104, the first entity receives an odometry measurement from the second entity that gives the position of the second entity as determined by the second entity. In an embodiment, the first entity may receive the odometry measurement as part of a continuous data stream from the second entity that is discretized into a segmented odometry. In some embodiments, the odometry measurement may contain only a relative change in position, rather than an absolute position.

Process 1100 includes determining a range estimation to the second entity based on a previous range to the second entity and the odometry measurement (operation 1106). In operation 1106, the first entity determines the range estimation to the second entity by adding the relative changed in position received in operation 1104 to a previous measured range to the second entity.

Process 1100 includes comparing the measured range to the second entity to the range estimation (operation 1108). In operation 1108, the first entity compares the range estimation determined in operation 1106 to the current measured range to the second entity.

Process 1100 includes determining if the measurements differ (decision block 1110). The process 1100 determines if the measurements differ by at least a predetermined distance. If the process 1100 determines that the measurements differ by at least the predetermined distance (“yes” branch, decision block 1110), then the process 1100 proceeds to operation 1112. If the process 1100 determines that the measurements do not differ by at least a predetermined distance (“no” branch, decision block 1110), then the process 1100 proceeds to operation 1114.

Process 1100 includes determining that an NLOS condition exists (operation 1112). In operation 1112, if the process 1100 determines that the measurements differ by at least the predetermined distance, then the difference between the measurements indicates that an NLOS condition exists. In an embodiment, the process 1100 sends a signal to a user that an NLOS condition exists.

Process 1100 includes determining that an NLOS condition does not exist (operation 1114). In operation 1114, if the process 1100 determines that the measurements do not differ by at least the predetermined distance, then the lack of a difference between the measurements indicates that an NLOS condition does not exist.

According to one aspect of the disclosure there is thus provided a system for two-way ranging, the system includes a first entity. The first entity includes: a first inertial measurement unit (IMU) circuitry configured to measure a first change in position of the first entity; radio circuitry configured to communicatively couple with one or more additional entities; and processor circuitry. The processor circuitry is configured to: measure a range to a second entity using two way ranging (TWR); receive an odometry measurement from the second entity; and determine a range estimation to the second entity based on a previous range to the second entity and the odometry measurement.

According to another aspect of the disclosure, there is thus provided a method for two-way ranging, the method including: measuring a range to a second entity from a first entity using two way ranging (TWR); receiving an odometry measurement on the first entity from the second entity; determine a range estimation to the second entity on the first entity based on a previous range to the second entity and the odometry measurement; comparing the measured range to the second entity to the range estimation to the second entity; and responsive to the comparison of the measured range to the second entity to the range estimation to the second entity differs by more than a predetermined distance, determining that a non-line of site (NLOS) condition exists between the first entity and the second entity.

According to yet another aspect of the disclosure, there is thus provided a system for two-way ranging, the system including a first entity. The first entity includes: a first inertial measurement unit (IMU) circuitry configured to measure a first change in position of the first entity; radio circuitry configured to communicatively couple with one or more additional entities; and processor circuitry. The processor circuitry is configured to: measure a range to a second entity using two way ranging (TWR); receive an odometry measurement from the second entity; determine a range estimation to the second entity based on a previous range to the second entity and the odometry measurement; compare the measured range to the second entity to the range estimation to the second entity; and responsive to the comparison of the measured range to the second entity to the range estimation to the second entity differs by more than a predetermined distance, determining that a non-line of site (NLOS) condition exists between the first entity and the second entity.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

What is claimed is:

1. A system for two-way ranging, the system comprising:
a first entity, the first entity comprising:
a first inertial measurement unit (IMU) circuitry configured to measure a first change in position of the first entity;
radio circuitry configured to communicatively couple with one or more additional entities; and
processor circuitry, the processor circuitry configured to:
measure a range to a second entity using two way ranging (TWR);
receive an odometry measurement from the second entity; and
determine a range estimation to the second entity based on a previous range to the second entity and the odometry measurement.

2. The system of claim 1 further comprising:
determine a measured range to the second entity using the TWR;
compare the measured range to the second entity and the range estimation to the second entity; and
responsive to the measured range and the range estimation differ by a predetermined distance, determine that a non-line of site (NLOS) condition exists between the first entity and the second entity.

3. The system of claim 1, wherein the odometry measurement includes a second change in a relative position since a last exchange of a previous odometry measurement.

4. The system of claim 1, wherein the odometry measurement is determined by a second IMU circuitry in the second entity.

5. The system of claim 1, wherein receive the odometry measurement from the second entity further comprises:
using the radio circuitry to receive the odometry measurement from the second entity.

6. The system of claim 1, wherein:
the odometry measurement is received in a data packet; and
the data packet complies with an 802.15.4 standard.

7. The system of claim 1, wherein measure the range to the second entity using the TWR further comprises:
measure an angle of arrival between the first entity and the second entity using the TWR.

8. The system of claim 1, further comprising:
reconstruct a shared time reference for the second entity.

9. The system of claim 8, wherein the shared time reference is reconstructed using at least one of assumed characteristics, measured characteristics, or known system characteristics.

10. The system of claim 1, further comprising:
reconstruct a shared coordinate frame between the first entity and the second entity.

11. A method for two-way ranging, the method comprising:
measuring a range to a second entity from a first entity using two way ranging (TWR);
receiving an odometry measurement on the first entity from the second entity;
determine a range estimation to the second entity on the first entity based on a previous range to the second entity and the odometry measurement;
comparing the measured range to the second entity to the range estimation to the second entity; and
responsive to the comparison of the measured range to the second entity to the range estimation to the second entity differs by more than a predetermined distance, determining that a non-line of site (NLOS) condition exists between the first entity and the second entity.

12. The method of claim 11, wherein the odometry measurement includes a second change in a relative position since a last exchange of a previous odometry measurement.

13. The method of claim 11, wherein receiving the odometry measurement on the first entity from the second entity further comprises:
using a radio circuitry to receive the odometry measurement from the second entity.

14. The method of claim 11, wherein:
the odometry measurement is received in a data packet; and
the data packet complies with an 802.15.4 standard.

15. The method of claim 11, wherein measuring the range to the second entity from the first entity using the TWR further comprises:
measuring an angle of arrival between the first entity and the second entity using the TWR.

16. The method of claim 11, further comprising:
reconstructing a shared time reference for the second entity.

17. The method of claim 16, wherein the shared time reference is reconstructed using at least one of assumed characteristics, measured characteristics, or known system characteristics.

18. The method of claim 11, further comprising:
reconstructing a shared coordinate frame between the first entity and the second entity.

19. A system for two-way ranging, the system comprising:
a first entity, the first entity comprising:
a first inertial measurement unit (IMU) circuitry configured to measure a first change in position of the first entity;
a first radio circuitry configured to communicatively couple with one or more additional entities; and
a first processor circuitry, the first processor circuitry configured to:
measure a range to a second entity using two way ranging (TWR);
receive an odometry measurement from the second entity;
determine a range estimation to the second entity based on a previous range to the second entity and the odometry measurement;
compare the measured range to the second entity to the range estimation to the second entity; and
responsive to the comparison of the measured range to the second entity to the range estimation to the second entity differs by more than a predetermined distance, determining that a non-line of site (NLOS) condition exists between the first entity and the second entity.

20. The system of claim 19, wherein the second entity comprises:
a second IMU circuitry configured to measure a second change in position of the second entity;
a second radio circuitry configured to communicatively couple with the one or more additional entities; and
a second processor circuitry.
